(19) United States
(12) Patent Application Publication
(10) Pub. No.: US 2009/0233615 A1
(43) Pub. Date: Sep. 17, 2009

(54) Method for enlarging the bandwidth of a group call

(76) Inventor: Harald Schmitt, Bendorf (DE)

Correspondence Address: SHLESINGER, ARKWRIGHT & GARVEY LLP, 1420 KING STREET, SUITE 600, ALEXANDRIA, VA, 22314, US

(21) Appl. No.: 11/921,218

(22) PCT Filed: May 30, 2006
(86) PCT No.: PCT/EP2006/005134

§ 371 Date: Nov. 29, 2007

(30) Foreign Application Priority Data
May 31, 2005 (DE) 10 2005 026 660.6

(51) Int. Cl. H04W 72/04; H04J 3/00

(52) U.S. Cl. 455/452.1; 455/450; 370/345

(57) ABSTRACT

The present invention relates to a method of enlarging a bandwidth available for a group call in a GSM network, in which, within a telephony channel (1) of the GSM network subdivided into a plurality of timeslots (TN0, . . . , TN7), a first (TN2) and at least one second (TN1, TN3) timeslot is allocated to the group call (VGC), the first timeslot (TN2) being provided for transmitting useful data of the group call (VGC) and the at least one second timeslot (TN1, TN3) being provided in order to supply additional bandwidth. Moreover, the present invention relates to a corresponding computer program and a computer program product.

### RELATED APPLICATIONS

This application is a national stage application of International PCT Application No. PCT/EP2006/005134, filed on May 30, 2006, claiming the priority benefit of Germany Application NO. 10 2005 026 660.6, filed on May 31, 2005, incorporated herein by reference.

### FIELD OF THE INVENTION

The present disclosure relates to a method of providing services in a communications network, particularly a GSM radio network. The present disclosure relates in particular to the simultaneous execution of a group call and so-called point-to-point services, particularly to a method for enlarging the bandwidth of a group call. Moreover, the present disclosure relates to a corresponding computer program product and a computer-readable data carrier.

### BACKGROUND OF THE INVENTION

In GSM (Global System for Mobile Communications) a so-called voice group call service (VGCS) is standardised which offers the possibility of a subscriber communicating with a number of subscribers. The VGCS thus constitutes a so-called point-to-multi-point service. Currently, subscribers who wish to participate in a voice group call can only carry out subscriber-specific point-to-point services parallel to an active VGC if they use special mobile terminals. Mobile terminals of this kind need to have two receiving units and at least one transmitting unit. This type of terminal belongs to the so-called class A of mobile terminals. From GPRS (General Packet Radio Service) a class A of terminals of this kind is already defined, the mobile terminals that belong to class A being characterised in that they can be used to carry out GPRS services and GSM transmission services at the same time. In GSM it is possible using such equipment to carry out subscriber-specific so-called point-to-point services such as an SMS transmission (Short Message Service), parallel to an active voice group call (VGC). Moreover, these types of mobile terminals offer the possibility of obtaining incoming connection wishes for so-called circuit switched (CS) and packet switched (PS) services during an active VGC. However, mobile terminals of the above-mentioned class A are currently unavailable or not available in sufficient numbers because of their complexibility. Furthermore, mobile terminals of the kind, when they do become available in sufficient numbers, will be in a high price bracket on account of their complexity.

Another possible way of providing active VGC subscribers with parallel point to point services is to use unused bandwidth of the voice group call radio channel or taking bandwidth from the voice group call. The GSM radio network currently contains the GSM900 and GSM1800 frequency band within its frequency spectrum. A transmission in GSM900 in the upward direction (uplink) of mobile terminals to a base station of the GSM radio network is operated in a frequency range from 880 MHz to 915 MHz, whereas a transmission in the downward direction (downlink) from a base station to a mobile terminal is operated in a frequency range from 925 MHz to 960 MHz. In GSM1800 the frequency range for the upward direction extends from 1,710 MHz to 1,785 MHz, whereas the frequency range for the downward direction extends from 1,805 MHz to 1,880 MHz. The frequency bands are subdivided into 125 radio channels each with a bandwidth of 200 kHz according to a so-called frequency multiplexing process. On each carrier frequency eight periodic timeslots are produced by a so-called time multiplexing method. A transmission channel is then. characterised by its carrier frequency and its available, periodically recurring timeslot. These physical channels used on an air interface have a timeslot that recurs every 4.615 ms. The physical channels, known as slots, are termed logic channels if they are used as speech or signal links. As a rule one physical channel corresponds to one logic channel. However, depending on the necessary transmission capacity, it is possible to operate a number of logical activities through one physical channel or to use a plurality of physical channels for the functions of one logic channel. Generally speaking, each subscriber is allocated a timeslot. After seven timeslots the subscriber in question can retransmit. Outside an allocated timeslot absolutely nothing is allowed to be transmitted so as not to interfere other subscribers. This switching on for a timeslot, followed by switching off, is also referred to as pulse or burst operation. Up to eight subscribers access a single frequency apparently simultaneously in the GSM. These eight timeslots are combined to form a so-called TDMA frame (Time Division Multiple Access). Each timeslot is 577 μs long and each TDMA frame is 4.615 ms long. A burst constitutes a fragment of a TDMA frame with the length of a timeslot, as already mentioned. A distinction is made between different types of bursts, the so-called “normal burst” being used for normal information exchange, signalling and speech.

As already mentioned, a physical channel is featured by the allocation of a frequency and a timeslot. Transmissions are sent in burst form through this physical channel. In principle, a distinction is made between useful data, such as speech, for example, and signalling data.

A voice group call as mentioned above is allocated a timeslot from a specified TDMA frame. This timeslot has a length of 577 μs and simultaneously corresponds to a particular frequency. If unused bandwidth is removed from a voice group call, as mentioned above, this can be used for example for sending SMS. Moreover, desired incoming connections for PS and CS services can be transmitted through this unused bandwidth on the part of the voice group call. This may be, for example, so-called inband paging or inband notification. By inband paging or inband notification is meant that desired incoming connections are sent within an existing logic channel, in this case the voice group call. By contrast, paging and notification is normally transmitted through a broadcast channel (BCCH) which is specific for a particular radio cell. The disadvantage of the option of using unused bandwidth is the limited amount of bandwidth available that can be used for point to point services and inband paging or notification. As a result, a plurality of parallel point to point services or so-called inband pagings/notifications cannot be transmitted. For the other option of removing bandwidth from the VGC, a further disadvantage of this is that the speech quality of the VGC service is additionally reduced.

Against the background of the prior art described, it was desirable to increase the bandwidth available for point to point services and inband paging/notification within an active VGC service. Thus it would be possible to carry out a plurality of parallel point to point services and inband pagings/notifications parallel to the active VGC service. In addition, the point to point services and inband signalling should not be allowed to impair the speech quality of the VGC.

For this purpose the present disclosure proposes a method having the features of claim 1, a computer program having the features of claim 10 and a computer program product having the features of claim 11.

### SUMMARY OF THE INVENTION

According to a broad aspect of the present patent application, a method of enlarging a bandwidth available for a group call in a GSM network is provided, in which a first and at least a second timeslot are allocated to the group call within a telephony channel of the GSM network subdivided into a plurality of timeslots, the first timeslot being provided for the transmission of useful data of the group call and the at least one second timeslot being provided for the provision of additional bandwidth.

It is possible for a plurality of timeslots to be assigned to the voice group call (VGC), the first timeslot being used, as mentioned above, for the transmission of useful data, e.g. in the form of speech or other data, whereas the minimum of one second or additional timeslots provide additional bandwidth.

In one embodiment of the method disclosed here it is envisaged that the first and the at least one second timeslot of the telephony channel constitute adjacent timeslots within the telephony channel. The at least one second additional timeslot, a so-called VGC signalling timeslot, provides additional bandwidth which can be used for different purposes.

It is possible for a logic channel to be allocated to the at least one second timeslot.

As already mentioned in the introduction, a physical channel is characterised by the allocation of a frequency and a timeslot. Transmission takes place through a physical channel of this kind in burst form. These physical channels, also known as slots, are referred to as logic channels if they are used for speech or signal links. As a rule, one physical channel corresponds to one logic channel. A slot is used by bursts each with a length of 148 bits which, so as to avoid overlapping with other bursts, are shorter than the slots by the safety interval, which corresponds to a duration of 8.25 bits. If messages are longer than 1 burst, they are divided between a plurality of bursts and then transmitted. The content of each timeslot is structured differently depending on the type of burst. The type of burst depends on the logic channel which a physical channel “carries”.

In the method described here it is possible for a standardised 3GPP logic channel to be allocated to the at least one second timeslot. 3GPP or 3rd General Partnership Project is a worldwide co-operation between standardising boards for standardisation in mobile telephony. For example the logic channels mentioned hereinafter may be allocated to the at least one second slot.

On the one hand there may be a combination of logic channels standardised according to 3GPP, each of which can be imaged on a physical channel. Multi-frames are defined for the arrangement of logic channels on a physical channel. A multi-frame consists of 26 or 51 TDMA frames and indicates the order in which the logic channels of a combination can succeed one another. A multi-frame is defined for each of the combinations listed below. A multi-frame for a single physical channel contains either 26 or 51 timeslots, which are situated one frame duration apart. For example, DCCH channels (Dedicated Control Channels) can be combined, namely an SDCCH/8 channel (Standalone Dedicated Control Channel) with an SACCH/8 channel (Slow Associated Dedicated Control Channel), what is formulated as “SDCCH/8+SACCH/8” combination. 8 corresponds to the number of subchannels in the above-mentioned DCCH channels. A subchannel is formed by subdividing a physical channel into a plurality of subunits, for example for transmitting speech, data or image signals. The term DCCH is a general term for three bidirectional point to point control channels through which signalling messages are transmitted at different bit rates for controlling the connection. An SDCCH channel is always operated as long as only control information or short text messages are being transmitted. Control information of the SDCCH relates, for example, to registration, authentication, location co-ordination and data regarding the connecting equipment. An SACCH channel is always allocated in parallel to a TCH channel (traffic channel) or an SDCCH channel. System information is transmitted from the network to the mobile station and measurement data regarding the level and reception quality is transmitted from the mobile station to the network through the SACCH at a data rate of 950 bits per second.

Furthermore, an FCCH channel (Frequency Correction Channel), an SCH channel (Synchronisation Channel), a BCCH channel (Broadcast Control Channel), a CCCH channel (Common Control Channel), an SDCCH/4 channel and an SACCH/8 channel can be combined with one another, this combination being formulated as “FCCH+SCH+BCCH+CCCH+SDCCH/4+SACCH/8”. An FCCH channel is generally a channel through which a so-called frequency correction burst is transmitted in order to correct a transmission frequency. An SCH channel can be used to transmit synchronisation bursts to the mobile station which then can synchronise with respect to time. A BCCH channel refers to a channel through which information is transmitted to a plurality of mobile stations through the network. This includes for example the identifier of the network, the availability of certain options such as frequency hopping, voice activity detection and the frequencies used by a fixed station and adjacent fixed stations. A CCCH channel denotes a control channel through which connecting functions between network and a mobile terminal are operated. The possible and permissible combinations of logic channels mentioned are documented in a technical specification by 3GPP, namely 3GPP TS 45.002, Chapter 6.4.

In addition to the combinations mentioned above it is also possible to use a CBCH channel (Cell Broadcast Channel) for the at least one second channel. The CBCH channel can be used in downlink traffic in order to operate a so-called short message service cell broadcast (SMSCB). The CBCH channel uses the same physical channel as an SDCCH channel.

Moreover, new logic channels which have not yet been specified in 3GPP can also be used for the at least one second timeslot. This may be, for example, a combination of a CCCH channel with an SDCCH/X channel. X denotes the number of SDCCH subchannels. Also, other combinations of SDCCH, SACCH, PCH and RACH channels are also possible. A PCH channel is a channel that exists only in downlink direction and is activated for selective addressing of a called mobile terminal when an attempt is being made at a connection from the network. PCH denotes paging channel. An RACH channel (Random Access Channel) is an access channel which occurs only in uplink direction and allows a mobile station to demand channel capacity from a fixed station for a desired connection, via a so-called S-ALOHA access process. Both the PCH channel and the RACH channel belong to the group of CCCH channels, i.e. the group of control channels, through which the connecting functions between network and a mobile terminal are operated.

The above-mentioned logic channels which can be allocated to the at least one second timeslot of the VGC may be used for different applications. An NCH channel which is part of a CCCH channel can be used, for example, for sending so-called inband notifications of other VGCs. A PCH channel (Paging Channel) which is also part of a CCCH channel can be used for sending inband pagings of CS (Circuit Switched) and PS (Packet Switched) services. An RACH channel, which is also part of a CCCH channel, can be used on the part of a subscriber of the VGC to obtain access to a point to point service. The RACH channel can accordingly be referred to as an access channel which, as already mentioned, occurs only in the uplink direction and enables a subscriber to request channel capacity for a desired connection from a fixed station by means of an access process. An SDCCH channel can be used for transmitting short messages, i.e. SMS. A BCCH channel is used for transmitting broadcast information, which may also be in the form of a broadcast SMS.

It should be mentioned that a CCCH channel should only be used once within a VGC. This means that in the event that a plurality of second timeslots have been allocated to the VGC, a CCCH channel should only be allocated to these second timeslots once. Generally, the combined BCCH+CCCH channel can also be transmitted on the at least one second VGC timeslot. In such a case, co-ordinated transmission of inband pagings and notifications is not necessary, as all the pagings and notifications of a telephony cell are transmitted through the combined BCCH+CCCH channel. In this case, there is no need for any co-ordination of pagings and notifications within the network.

As a result of the additional signalling capacity in the VGC in the form of the at least one second timeslot it is possible to carry out point to point services as well as transmitting inband signalling without any loss of the speech quality of the VGC as there is no need to take any bandwidth from the VGC speech timeslot. As a result, the speech quality of the VGC becomes independent of the number of inband signalling messages to be sent and the activated point to point services.

In another embodiment of the proposed method, the at least one second timeslot is allocated dynamically depending on the bandwidth required. This allocation requires, on the network side, a coordinated allocation of VGC speech and VGC signalling timeslots. On the part of a subscriber to the VGC there is a need to support so-called multi-slot allocations. A multi-slot support is already required by the GPRS service (General Packet Radio Service). It is conceivable that the GPRS multi-slot capability of a mobile terminal which is provided by a GPRS multi-slot category can be used for the method according to the invention. On the network side the GPRS multi-slot category of the mobile terminal has to be taken into consideration during the co-ordinated allocation of VGC speech and signalling timeslots.

In another possible embodiment of the method described, new specific multi-slot categories are defined for a mobile terminal participating in a VGC.

In addition, it is possible that the at least one second timeslot is allocated to a number of group calls. This means that in order to provide additional bandwidth for further services an active VGC participates in the additional bandwidth allocated to another active VGC, in form of the at least one second timeslot. This procedure is very effective as it means that the additional bandwidth provided in form of the at least one second timeslot can be effectively used by the active VGCs. For example, a VGC signalling timeslot at timeslot number X can be used by two VGCs, the speech timeslots of which are located at timeslot number X−1 and X+1, respectively.

Moreover, the present disclosure comprises a computer readable data carrier with a computer program having program coding means, with which all the steps of the method disclosed can be carried out if the computer program is run on a computer or a suitable computing unit. A corresponding computer program product is also included.

Further features and advantages will become apparent from the description and the attached drawings.

It will be appreciated that the features mentioned above and those to be described hereinafter can be used not only in the particular combination specified but also in other combinations or on their own without departing from the scope of the present disclosure.

### BRIEF DESCRIPTION OF THE DRAWINGS

An embodiment by way of example is diagrammatically shown in the drawings and described in detail hereinafter with reference to the drawings.

FIG. 1 shows an example of an embodiment of the method disclosed.

### DETAILED DESCRIPTION OF THE DRAWINGS

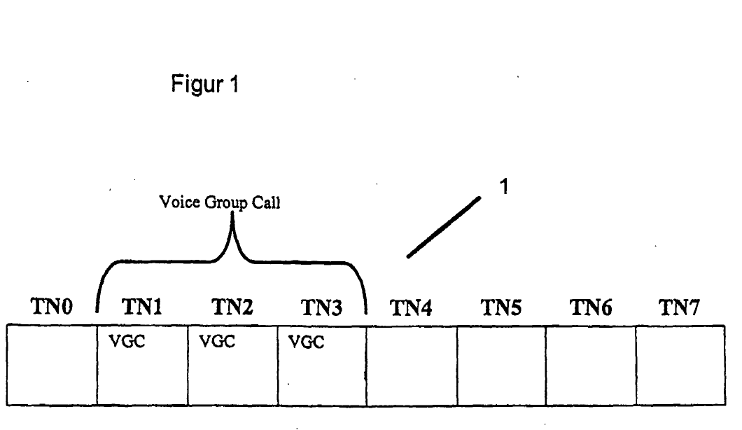

FIG. 1 shows a telephony channel 1 of a GSM network. The channel 1 is divided into eight timeslots TN0 to TN7. Each of the eight timeslots is about 0.57 ms long. The eight timeslots TN0 to TN7 together form a so-called TDMA frame. This subdivision produces eight physical channels, as a result of which channel 1 can supply eight users. This method of dividing up a channel is referred to as “time division multiple access” (TDMA). The data quantity of 156.25 bits transmitted in a timeslot TN0 to TN7 is referred to as a burst. Each of the eight physical channels TN0 to TN7 is characterised by its carrier frequency and the timeslot available to it, which recurs every 4.615 ms. The physical channels TN0 to TN7 are referred to as logic channels as soon as they are used as speech or signalling links. In the case described here, the channel TN2 is used as a speech channel for a voice group call (VGC). The channels TN1 and TN3 adjacent to this channel TN2 are used as VGC signalling channels or timeslots. By allocating the additional channels TN1 and TN3 to a voice group call the bandwidth of the voice group call is increased. This means that using the channels TN1 and TN3 it is possible for one or more participants in the VGC to make use of other so-called point to point services parallel to their respective active participation in the VGC. These other point to point services are then initiated and transmitted through the channels TN1 or TN3. These point to point services may be, for example, an SMS (Short Message Service) inband paging or inband notification. Paging selectively addresses a participant in the VGC who is being called and for whom there is a desired connection from the network, i.e. an incoming call. Moreover, through the additional bandwidth provided, information can be transmitted through the network to the participants in the VGC in parallel to the active VGC, corresponding to inband notification. The desired incoming connections can be transmitted for so-called packet switched or circuit switched services. Owing to the fact that the above-mentioned services can be transmitted by means of the additional bandwidth provided, parallel to the active VGC, no bandwidth is taken from the VGC and consequently the speech quality of the VGC service is not reduced either.

It is possible for another VGC to be activated, the speech timeslot of which is located at timeslot TN4, so that this VGC, in addition to the VGC whose speech timeslot is located at TN2, uses the VGC signalling timeslot at TN3. This further improves the utilisation of the additional bandwidth provided.

It is also possible for the VGC signalling timeslots TN1 and TN3 to be switched on dynamically as required for the VGC whose speech timeslot is at TN2. This dynamic allocation means that two channels, in this case TN1 and TN3, do not have to be needlessly occupied for long periods by one VGC.

1. Method of enlarging a bandwidth available for a group call in a GSM network, in which, within a telephony channel (1) of the GSM network subdivided into a plurality of timeslots (TN0 . . . , TN7), a first (TN2) and at least one second (TN1, TN3) timeslot is allocated to the group call (VGC), the first timeslot (TN2) being provided for transmitting useful data of the group call (VGC) and the at least one second timeslot (TN1, TN3) being provided in order to supply additional bandwidth.

2. Method according to claim 1, wherein the first (TN2) and the at least one second timeslot (TN1, TN3) of the telephony channel (1) are selected as adjacent timeslots within the channel (1).

3. Method according to claim 1, wherein a logic channel is allocated to the at least one second timeslot (TN1, TN3).

4. Method according to claim 3, wherein a logic channel standardised in 3GPP is allocated to the at least one second timeslot (TN1, TN3).

5. Method according to claim 1 one of claims 1, wherein the at least one second timeslot (TN1, TN3) is dynamically allocated depending on the bandwidth required.

6. Method according to claim 1, wherein the at least one second timeslot (TN1, TN3) is allocated to a plurality of group calls.

7. Method according to claim 1, wherein the additional bandwidth of the at least one second timeslot (TN1, TN3) is used for point to point services, particularly SMS services.

8. Method according to claim 1, wherein the additional bandwidth of the at least one second timeslot (TN1, TN3) is used for transmitting incoming desired connections for speech and data links to a party participating in the group call.

9. Method according to claim 1, wherein the additional bandwidth of the at least one second timeslot (TN1, TN3) is used for paging and/or notification.

10. Computer program product having a computer program with program coding means stored on a computer readable data carrier, by means of which all the steps of a method according claim 1 can be carried out when the computer program is executed on a computer or a corresponding computing unit.

11. Computer readable data carrier on which a computer program with program coding means is stored, by means of which all the steps of a method according to claim 1 can be carried out when the computer program is executed on a computer or a corresponding computing unit.
